(19) United States
(12) Patent Application Publication
(10) Pub. No.: US 2020/0313176 A1
(43) Pub. Date: Oct. 1, 2020

(54) ELECTRODE AND ELECTROCHEMICAL DEVICE INCLUDING THE SAME

(71) Applicant: NINGDE AMPEREX TECHNOLOGY LIMITED, Ningde City (CN)

(72) Inventors: Huixin WANG, Ningde City (CN); Silin HUANG, Ningde City (CN); Sheng CHENG, Ningde City (CN); Hongming YU, Ningde City (CN)

(73) Assignee: NINGDE AMPEREX TECHNOLOGY LIMITED

(21) Appl. No.: 16/534,326

(22) Filed: Aug. 7, 2019

(30) Foreign Application Priority Data
Mar. 29, 2019 (CN) 201910251838.0

(51) Int. Cl. H01M 4/38; H01M 4/133; H01M 10/0525

(52) U.S. Cl. CPC H01M 4/386; H01M 2004/028; H01M 10/0525; H01M 4/133

(57) ABSTRACT

The present application relates to an electrode and an electrochemical device including the electrode. The electrode includes a first region and a second region, wherein the electrode includes a substrate and an electrode active material coated on at least one surface of the substrate, and wherein the charge/discharge thickness difference of the electrode in the first region is ΔD₁, and the charge/discharge thickness difference of the electrode in the second region is ΔD₂, wherein ΔD₁ is less than ΔD₂. When the electrode of the present application is applied to the electrochemical device, the formation of lithium dendrites can be effectively reduced, and the safety of the electrochemical device can be improved.

### CROSS REFERENCE TO RELATED APPLICATIONS

The present application claims the benefit of priority from the China Patent Application No. 201910251838.0, filed on 29 Mar. 2019, the disclosure of which is hereby incorporated by reference in its entirety.

### BACKGROUND

### 1. Technical Field

The present application relates to the field of energy storage technologies, more particularly to an electrode and an electrochemical device including the electrode.

### 2. Description of the Related Art

With the popularity of consumer electronics products such as notebook computers, mobile phones, handheld game consoles, tablet computers, mobile power supplies, and drones, the requirements for electrochemical devices (for example, batteries) have become ever more stringent. For example, people require not only light weight but also high capacity and long service life of the batteries. Among the numerous types of batteries available, lithium-ion batteries have occupied an established position due to their outstanding advantages, such as high energy density, notable safety, low self-discharge, no memory effect, and long service life.

However, up to now, the safety of electrochemical devices has not been effectively guaranteed. For example, when a lithium-ion battery undergoes a long-term charge and discharge cycle, lithium is precipitated on the surface of the electrode of the lithium-ion battery, particularly on the surface of the anode, forming lithium dendrites. The formation of lithium dendrites will inevitably cause a breakdown of the separator between the anode and the cathode, resulting in the direct contact of the cathode and the anode and thus causing an electrochemical short circuit, thereby greatly reducing the safety of the battery cell. Therefore, improving the safety of electrochemical devices is an important research topic in the field.

### SUMMARY

The present application provides an electrode, and a battery cell and an electrochemical device including the electrode in an attempt to solve at least one of the problems existing in the related field at least to some extent.

In one embodiment, the present application provides an electrode, including a first region and a second region, wherein the electrode includes a substrate and an electrode active material coated on at least one surface of the substrate, and wherein the charge/discharge thickness difference of the electrode in the first region is ΔD₁, and the charge/discharge thickness difference of the electrode in the second region is ΔD₂, wherein ΔD₁ is less than ΔD₂.

In some embodiments, the thickness of the electrode in the first region is L₁, and the thickness of the electrode in the second region is L₂, wherein L₂ is substantially equal to L₁.

In some embodiments, the thickness L₁ of the electrode in the first region is substantially equal to the thickness L₂ of the electrode in the second region during the preparation of the electrode.

In some embodiments, the thickness L₁ of the electrode in the first region is substantially equal to the thickness L₂ of the electrode in the second region during or after the formation of the battery cell.

In some embodiments, the first region includes a body region, and the second region includes an edge region.

In some embodiments, the first region and the second region respectively include electrode active materials having substantially the same charge expansion ratio.

In some embodiments, the first region and the second region respectively include electrode active materials having different charge expansion ratios.

In some embodiments, the first region and the second region respectively include the same electrode active material.

In some embodiments, the first region and the second region respectively include different electrode active materials.

In some embodiments, the electrode active material in the first region includes a ternary material, and the electrode active material in the second region includes lithium cobalt oxide.

In some embodiments, the electrode active material in the first region and the electrode active material in the second region include a carbon material, and wherein the OI value of the carbon material in the first region is less than the OI value of the carbon material in the second region.

In some embodiments, the electrode active material in the first region and the electrode active material in the second region include a carbon material, wherein the degree of graphitization of the carbon material in the first region is less than the degree of graphitization of the carbon material in the second region.

In some embodiments, the electrode active material in the first region includes graphite, and the electrode active material in the second region includes silicon.

In some embodiments, the electrode active material in the first region includes hard carbon, and the electrode active material in the second region includes graphite and/or silicon.

In some embodiments, the electrode can be used as an anode and/or a cathode in the electrochemical device.

In one embodiment, the present application further provides a battery cell, including the electrodes in the above embodiments.

In one embodiment, the present application further provides an electrochemical device, including the battery cell of the present application.

In some embodiments, the electrochemical device is a lithium-ion battery.

By performing differential settings in different regions of the electrode of the battery cell, the present application improves the uneven deposition of lithium in different regions of the electrode of the battery cell, reduces the probability of the formation of lithium dendrites and the possibility of an electrochemical short circuit, thereby greatly enhancing the safety of the battery cell. Additional aspects and advantages of the embodiments of the present application will be described or shown in the following description or interpreted by implementing the embodiments of the present application.

### BRIEF DESCRIPTION OF THE DRAWINGS

The following will briefly illustrate the accompanying drawings necessary to describe the embodiments of the present application or the existing technology so as to facilitate the description of the embodiments of the present application. Obviously, the accompanying drawings described below are only part of the embodiments of the present application. For those skilled in the art, the accompanying drawings of other embodiments can still be obtained according to the structures illustrated in the accompanying drawings without any creative effort.

FIG. 1 shows a structure of a common electrode in the prior art; and

FIG. 2 shows a schematic structural view of a partitioned electrode in some embodiments of the present application.

Reference numeral 1 denotes a body region;

Reference numeral 2 denotes an empty foil region;

Reference numeral 3 denotes a substrate;

Reference numeral 4 denotes an edge thin region; and

Reference numeral 5 denotes an edge region.

### PREFERRED EMBODIMENT OF THE PRESENT APPLICATION

Embodiments of the present application are described in detail below. Throughout the specification, the same or similar components and components having the same or similar functions are denoted by similar reference numerals. The embodiments described herein with respect to the accompanying drawings are illustrative and graphical, and are used for providing a basic understanding on the present application. The embodiments of the present application should not be construed as limiting the present application.

As used herein, the terms “substantially”, “generally”, “essentially” and “about” are used to describe and explain small variations. When being used in combination with an event or circumstance, the term may refer to an example in which the event or circumstance occurs precisely, and an example in which the event or circumstance occurs approximately. For example, when being used in combination with a value, the term may refer to a variation range of less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, if the difference value between the two values is less than or equal to ±10% of the average of the values (for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%), then the two values can be considered “substantially” the same.

In addition, amounts, ratios and other numerical values are sometimes presented herein in a range format. It should be appreciated that such range formats are for convenience and conciseness, and should be flexibly understood as comprising not only values explicitly specified to range constraints, but also all individual values or sub-ranges within the ranges, like explicitly specifying each value and each sub-range.

The term “body region” is a region where a main electrode active material is coated or a main region where an electrode active material is coated. For example, in some embodiments of the present application, different electrode active materials A and B are respectively coated in different regions of the electrode, wherein the electrode active material A is the main electrode active material, and thus the region where the active material A is coated is the body region. For another example, in some embodiments of the present application, the same electrode active material is coated in different regions C and D of the electrode, wherein the area of the region C is large, and thus the region C is the body region.

The term “edge region” is a region that is a few millimeters to tens of millimeters (e.g., about 3 mm to 40 mm) from the edge of the body region. In some embodiments of the present application, the edge region may be, but is not limited to, a region about 30 mm from the edge of the body region, a region about 20 mm from the edge of the body region, a region about 10 mm from the edge of the body region, or a region about 5 mm from the edge of the body region.

### I. ELECTRODE

Taking lithium-ion batteries as an example, electrodes currently used in lithium-ion batteries have various structural categories, such as the multi-tab wound structure (MTW), full-tab wound structure (FTW), stack structure and the like. Generally, an electrode of a lithium-ion battery includes a substrate (also referred to as a current collector) and an electrode active material on at least one surface of the substrate, wherein most of the substrates are a metal material for the function of transmitting electrons, and the electrode active material is capable of converting chemical energy into electrical energy.

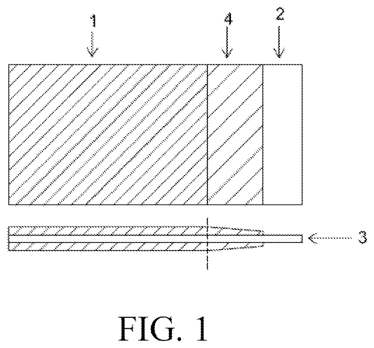

FIG. 1 shows a structure of a common electrode in the prior art. As shown in FIG. 1, in the process of preparing an electrode, the electrode is generally divided into an active material region and an empty foil region (also referred to as a tab region) in the prior art, wherein the empty foil region is a region that is a few millimeters to tens of millimeters from the edge of the substrate without being coated with any electrode active material for attaching the tabs.

The active material region in the electrode is generally not partitioned in the prior art. When the electrode active material is coated onto the active material region, since most of the slurry exhibits a liquid state and has fluidity, the slurry inevitably flows to the empty foil region. Since the flow rate of the solid particles (for example, the electrode active material) in the slurry is smaller than the flow rate of the liquid molecules (for example, a solvent), it results in that, as compared to the active material region, the empty foil region has less electrode active material and thus is thinner when forming the edge thin region.

An electrochemical device typically includes a battery cell, and the battery cell typically includes an anode, a cathode and a separator, wherein the separator is disposed between the anode and the cathode to prevent a short circuit. Before the battery cell is applied to the electrochemical device, it is usually necessary to form the battery cell. In the formation stage, the battery cell is simultaneously subjected to a charge and discharge cycle and a pressing process to activate the anode and the cathode, and the anode, the separator and the cathode are tightly compacted together to enhance the stability of the battery cell and reduce the volume of the battery cell, thereby improving the cycle stability of the battery cell and increasing the volumetric specific capacity of the battery cell.

In the formation stage, the active material on the electrode undergoes volume expansion during the progress of charge and discharge. For example, in the case of a lithium-ion battery, the charge process is a process in which lithium ions are intercalated in the anode active material, and the discharge process is a process in which lithium ions are intercalated in the cathode active material. As described above, the electrode in the prior art has a thick region (for example, a body region) and a thin region (for example, an edge region). When the same pressure is applied to the surface of the battery cell during the pressing process, the electrode of the thin region is less pressed compared with the electrode of the thick region. This may result in a weak adhesion between the anode of the thin region, the separator and the cathode of the thin region, so that it is difficult to achieve a close fit among them, resulting in local interface separation as the number of charge and discharge cycles increases.

When local interface separation occurs among the anode, the separator and the cathode, uneven distribution of current density on the electrode surface is caused and it is difficult for a part of the electrode active material of the electrode to exert electrochemical activity. For example, when an excess of lithium ions are present in the thin region of the anode, since the anode active material in the thin region of the anode cannot completely “absorb” these lithium ions, some of these lithium ions are deposited on the surface of the anode, forming lithium dendrites. The formation of the lithium dendrites will largely break the separator, causing the direct contact between the cathode and the anode and thus generating an electrochemical short circuit, thereby greatly reducing the safety of the battery cell.

At least in order to overcome the above defects, in the present application, the electrode is divided into a plurality of regions for differential coating. A material having a large thickness change after charge or discharge is coated on the thin region, so that the charge/discharge thickness difference of the thin region is greater than the charge/discharge thickness difference of the thick region. And by compensating for the thickness of the significantly thin region of the electrode after coating, the thickness of the plurality of regions of the electrode is substantially the same.

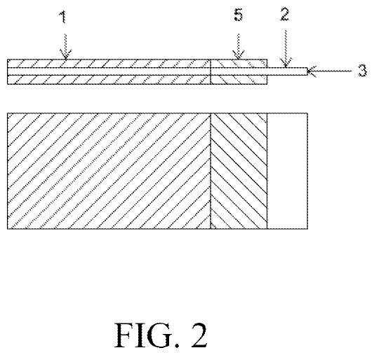

FIG. 2 shows a schematic structural view of a partitioned electrode in some embodiments of the present application. As shown in FIG. 2, in some embodiments of the present application, the electrode includes a substrate and an electrode active material coated on at least one surface of the substrate, wherein the electrode includes a first region (e.g., a body region) and a second region (e.g., an edge region), wherein the thickness of the electrode in the first region is L₁, and the thickness of the electrode in the second region is L₂, wherein L₂ is substantially equal to L₁. In some embodiments of the present application, the range defined by “substantially equal to” is when the ratio of the difference between a larger value and a smaller value to the larger value is greater than or equal to 0 and less than or equal to 2%. For example, the range of “L₂ is substantially equal to L₁” here is: 0≤(L₁−L₂)/L₁)≤2%.

Since different regions have substantially the same electrode thickness, when the electrode is subjected to the same force between the clamps of a formation device everywhere, each region of the electrode has substantially the same interface adhesion as the body region. In the case that a body region cannot produce an interface separation, other regions will also not generate local interface separation due to uneven forces. Therefore, it greatly reduces the probability of lithium ions forming lithium dendrites on the surface of the anode, and enhances the safety of the battery cell.

The present application does not limit the values of the thicknesses in the first region and the second region of the electrode. In some embodiments of the present application, the thickness L₁ of the electrode in the first region and the thickness L₂ of the electrode in the second region may be, but are not limited to be, in the range of about 10 μm-about 500 μm. For example, L₁ or L₂ may be, but are not limited to, about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, about 150 μm, about 160 μm, about 170 μm, about 180 μm, about 190 μm, about 200 μm, about 220 μm, about 240 μm, about 260 μm, about 280 μm, about 300 μm, about 320 μm, about 340 μm, about 360 μm, about 380 μm, about 400 μm, about 420 μm, about 440 μm, about 460 μm, about 480 μm, or about 500 μm.

In some embodiments of the present application, the thickness L₁ of the electrode in the first region is substantially equal to the thickness L₂ of the electrode in the second region during the preparation of the electrode.

In some embodiments of the present application, the thickness L₁ of the electrode in the first region is substantially equal to the thickness L₂ of the electrode in the second region during the formation of the battery cell.

In some embodiments of the present application, it is not necessary to make the thickness L₁ of the electrode in the first region substantially equal to the thickness L₂ of the electrode in the second region during the stage of preparing the electrode, and it only needs to realize that L₁ is substantially equal to L₂ in the formation stage or after the formation of the battery cell. That is, even in the case where a thin region of an electrode occurs during the preparation of the electrode, as long as the thickness of the thin region can be compensated in the formation stage of the battery cell to compensate for the difference in thickness between the thin region and the thick region, it can also achieve substantially equal thicknesses of the two different regions described above.

In some embodiments of the present application, the first region includes a body region and the second region includes an edge region.

Furthermore, the above-mentioned “empty foil region” is a blank region left for attaching the tabs in the process of preparing the electrode, and the prepared electrode does not necessarily include the empty foil region.

In some embodiments of the present application, the first region and the second region respectively include electrode active materials having substantially the same charge expansion ratio. The “charge expansion ratio” refers to the volume expansion ratio of the charged electrode active material compared to the uncharged electrode active material. “Having substantially the same charge expansion ratio” means that the electrode active materials in the first region and the second region undergo substantially the same degree of expansion during charge. Since different electrode active materials may have substantially the same charge expansion ratio, in some embodiments of the present application, the first region and the second region may employ different electrode active materials. Of course, in some embodiments of the present application, the first region and the second region may employ the same electrode active material. In the above embodiments, if it is desired to obtain electrodes having substantially the same thickness, it is necessary to coat the electrode active material with the same thickness on the substrates in the first region and the second region respectively in the process of preparing the electrode.

In some embodiments of the present application, the first region and the second region respectively include electrode active materials having substantially different charge expansion ratios. That is, the electrode active materials in the first region and the second region undergo expansion of different degrees during charge. For example, in the case where an edge thin region occurs during the preparation of the electrode, an electrode active material having a larger charge expansion ratio can be coated on the edge thin region to compensate for the charge/discharge thickness difference between the body region and the edge region in the preparation stage.

The electrode described in the present application can be used as a cathode in the electrochemical device, and can also be used as an anode in the electrochemical device. The electrode active material which can be used as a cathode and an anode of a lithium-ion battery will be specifically described below.

(I) Cathode

In some embodiments of the present application, a cathode of a lithium-ion battery includes a cathode substrate (also referred to as a cathode current collector) and a cathode active material on at least one surface of the cathode substrate. In some embodiments, the cathode substrate may be, but is not limited to, aluminum foil or nickel foil.

The cathode active material of the lithium-ion battery includes a cathode material capable of absorbing and releasing lithium (Li) (hereinafter, sometimes referred to as “a cathode material capable of absorbing/releasing lithium Li”). Examples of the cathode material capable of absorbing/releasing lithium (Li) may include, but are not limited to, lithium cobalt oxide, a ternary material, lithium manganate, lithium manganese iron phosphate, lithium vanadium phosphate, oxylithium vanadium phosphate, lithium iron phosphate, lithium titanate and a lithium-containing manganese-based material.

In the above cathode material, the chemical formula of lithium cobalt oxide may be, but is not limited to, LiₓCoₐM1_{b}O_{2-c}H_{d}, wherein M1 is selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), silicon (Si), and a combination thereof, wherein H is selected from the group consisting of fluorine (F), sulfur (S), boron (B), nitrogen (N) or phosphorus (P), and a combination thereof, and the values of x, a, b and c are respectively in the following ranges: 0.8≤x≤1.2, 0.8≤a≤1, 0≤b≤0.2, −0.1≤c≤0.2, and 0≤d≤0.2.

In the above cathode material, the ternary material refers to a material capable of reversibly intercalating and deintercalating lithium ions, which is composed of a lithium element, three different metal elements other than the lithium element, and an oxygen element. In some embodiments, the chemical formula of the ternary material may be Li_{y}M2ₑM3_{f}M4_{g}O₂₋ₕ, wherein M2-M4 are selected from the group consisting of nickel (Ni), cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), zirconium (Zr), silicon (Si) and a combination thereof, the values of y, e, f, g and h are respectively in the following ranges: 0.8≤y≤1.2, 0.3≤e≤0.98, 0.02≤f≤0.7, 0.02≤g≤0.7, −0.1≤h≤0.2. In some embodiments of the present application, the ternary material includes lithium nickel cobalt manganese oxide and/or lithium nickel cobalt aluminum oxide.

In the above cathode material, the chemical formula of lithium manganate is Li_{z}Mn₂₋ₚM5ₚO₄₋ᵣ, wherein M5 is selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W) and a combination thereof, and the values of z, p and r are respectively in the following ranges: 0.8≤z≤1.2, 0≤p<1.0 and −0.2≤r≤0.2.

In some embodiments of the present application, the electrode active material in the first region of the cathode includes, but is not limited to, a ternary material, and the electrode active material in the second region of the cathode includes, but is not limited to, lithium cobalt oxide, wherein the charge expansion ratio of the ternary material is less than that of the lithium cobalt oxide. In the above embodiment, even if the thickness of the electrode in the second region is less than the thickness of the electrode in the first region during the preparation of the electrode, as long as the lithium cobalt oxide undergoes a large expansion after the formation phase of the battery cell to compensate for the charge/discharge thickness difference of the electrode in the first region and the second region, it can still achieve substantially equal thicknesses of the above two regions.

(II) Anode

In some embodiments of the present application, an anode of a lithium-ion battery includes an anode substrate (also referred to as an anode current collector) and an anode active material on at least one surface of the anode substrate. In some embodiments, the anode substrate may be, but is not limited to, copper foil or nickel foil.

The anode active material of the lithium-ion battery includes an anode material capable of absorbing and releasing lithium (Li) (hereinafter, sometimes referred to as “an anode material capable of absorbing/releasing lithium Li”). The anode material capable of absorbing/releasing lithium (Li) may include, but is not limited to, a carbon material, a metal compound, an oxide, a sulfide, a nitride of lithium such as LiN₃, a lithium metal, and a metal which forms an alloy with lithium, and a polymer material.

The carbon material may include, but is not limited to, low graphitized carbon, easily graphitized carbon, artificial graphite, natural graphite, mesocarbon microbeads, soft carbon, hard carbon, pyrolytic carbon, coke, vitreous carbon, an organic polymer-compound sintered body, carbon fiber and activated carbon. The coke may include pitch coke, needle coke and petroleum coke. The organic polymer-compound sintered body refers to a material obtained by calcining a polymer material (for example, phenol plastic or furan resin) at a suitable temperature and carbonizing the same. These materials can be classified into low graphitized carbon or easily graphitized carbon. The polymer material may include, but is not limited to, polyacetylene and polypyrrole.

Further, in these anode materials capable of absorbing/releasing lithium (Li), materials which have charging and discharging voltages close to the charging and discharging voltages of lithium metal can be selected. This is because the lower the charging and discharging voltages of the anode material are, the easier it is for the lithium-ion battery to have higher energy density. Carbon materials can be selected as the anode material because their crystal structures only slightly change during charging and discharging, therefore good cycle characteristics and large charging and discharging capacities can be obtained. In particular, graphite may be selected because the graphite can provide a large electrochemical equivalent and a high energy density.

Further, the anode material capable of absorbing/releasing lithium (Li) may include elemental lithium metals, metal elements and semi-metal elements capable of forming alloys together with lithium (Li), alloys and compounds including such elements, etc. In particular, the above materials are used together with the carbon material since in such a case, good cycle characteristics as well as high energy density can be obtained. In addition to the alloys including two or more metal elements, the alloys used here also include alloys including one or more metal elements and one or more semi-metal elements. The alloy may be in one of the following states: a solid solution, a eutectic crystal (eutectic mixture), an intermetallic compound, and a mixture thereof.

Examples of the metal elements and the semi-metal elements can include stannum (Sn), plumbum (Pb), aluminum (Al), indium (In), silicon (Si), zinc (Zn), stibium (Sb), bismuth (Bi), cadmium (Cd), magnesium (Mg), boron (B), gallium (Ga), germanium (Ge), arsenic (As), silver (Ag), zirconium (Zr), yttrium (Y) or hafnium (Hf). Examples of the above alloys and compounds may include a material having a chemical formula: MaₛMbₜLiᵤ and a material having a chemical formula: MaₚMc_{q}Mdᵣ. In these chemical formulas, Ma denotes at least one of the metal elements and the semi-metal elements capable of forming an alloy together with lithium; Mb denotes at least one of the metal elements and the semi-metal elements except lithium and Ma; Mc denotes at least one of the non-metal elements; Md denotes at least one of the metal elements and the semi-metal elements except Ma; and s, t, u, p, q and r satisfy s>0, t≥0, u≥0, p>0, q>0 and r≥0.

In addition, an inorganic compound not including lithium (Li), such as MnO₂, V₂O₅, V₆O₁₃, NiS and MoS, may be used in the anode.

In some embodiments of the present application, the electrode active material in the first region of the anode and the electrode active material in the second region of the anode include a carbon material, wherein the OI value of the carbon material in the first anode region is less than the OI value of the carbon material in the second anode region. The OI value is an orientation index of a graphite layered structure in the carbon material, wherein the larger the OI value is, the more parallel the graphite layered structure in the carbon material is to the substrate. In the present application, the OI value is measured by an X-ray diffractometer (XRD), wherein OI=C(004)/C(110), C(004) represents the intensity of the diffraction peak of the (004) crystal plane of the carbon material, and C(110) represents the intensity of the diffraction peak of the (110) crystal plane of the carbon material. In some embodiments of the present application, the carbon material includes a graphite material.

In the above embodiment, the OI value of the carbon material being larger indicates that the lithium ions can be intercalated in the carbon material more easily, so the volume expansion ratio of the carbon material is larger. In the above embodiment, even if the thickness of the electrode in the second region is less than the thickness of the electrode in the first region during the preparation of the electrode, as long as the carbon material having a larger OI value undergoes a large expansion in the formation stage or after the formation of the battery cell to compensate for the charge/discharge thickness difference of the electrode in the first region and the second region, it can still achieve substantially equal thicknesses of the above two regions.

In some embodiments of the present application, the electrode active material in the first region of the anode and the electrode active material in the second region of the anode include a carbon material, wherein the degree of graphitization of the carbon material in the first region of the anode is less than the degree of graphitization of the carbon material in the second region of the anode. The degree of graphitization is an index for measuring the order of carbon atoms arranged in a carbon material. The more the arrangement of carbon atoms is ordered, the higher the degree of graphitization. In the present application, the degree of graphitization G is measured by an XRD, wherein G=(0.172-d₀₀₄)/(0.172−0.16769)×100%, d₀₀₄=0.07709/sin θ, θ is the diffraction angle of the (004) crystal plane of the carbon material. In some embodiments of the present application, the carbon material includes a graphite material.

In the above embodiment, the degree of graphitization of the carbon material being larger indicates that the lithium ions can be intercalated in the carbon material more easily, so the volume expansion ratio of the carbon material is larger. In the above embodiment, even if the thickness of the electrode in the second region is less than the thickness of the electrode in the first region during the preparation of the electrode, as long as the carbon material having a larger degree of graphitization undergoes a large expansion in the formation stage of the battery cell or after the formation to compensate for the charge/discharge thickness difference of the electrode in the first region and the second region, it can still achieve substantially equal thicknesses of the above two regions.

In some embodiments of the present application, the electrode active material in the first region of the anode includes graphite, whereas the electrode active material in the second region of the anode includes silicon. During the charge and discharge process (that is, during the process of intercalating lithium ions into the anode material or deintercalating lithium ions from the anode material), the volume expansion ratio of silicon is greater than the volume expansion ratio of graphite.

In some embodiments of the present application, the electrode active material in the first region includes hard carbon, and the electrode active material in the second region includes graphite and/or silicon, wherein the volume expansion ratio of the graphite or silicon is greater than that of the hard carbon during the charge and discharge process.

(III) Electrode Including Third Region

In some embodiments of the present application, the electrode further includes a third region, wherein the third region is arranged adjacent to the second region but apart from the first region. The arrangement principle of the third region is similar to that in the second region, both for compensating for the difference in thickness of the thin region to obtain the electrode having substantially the same thickness. The thickness of the electrode in the third region is L₃, wherein L₃ is substantially equal to Li. The present application does not limit the value of the thickness of the electrode in the third region. In some embodiments of the present application, the thickness L₃ of the electrode in the third region may be in the same range as the thickness L₁ or L₂.

In some embodiments of the present application, the thickness L₃ of the electrode in the third region is made substantially equal to the thickness L₁ of the electrode in the first region during the preparation of the electrode.

In some embodiments of the present application, the thickness L₃ of the electrode in the third region is made substantially equal to the thickness L₁ of the electrode in the first region during the formation of the battery cell.

In some embodiments of the present application, it is not necessary to make the thickness L₃ of the electrode in the third region substantially equal to the thickness L₁ of the electrode in the first region in the stage of preparing the electrode, and it is only necessary to realize that L₁ is substantially equal to L₃ in the formation stage of the battery cell. That is, even in the case where a thin area of the electrode appears during the preparation of the electrode, as long as the electrode active material of the third region is capable of undergoing a large expansion in the formation stage of the battery cell to compensate for the charge/discharge thickness difference of different regions, a substantially equal thickness of the electrode in the different regions described above can still be achieved.

In some embodiments of the present application, the first region includes a body region, the second region includes a first edge region, and the third region includes a second edge region, wherein the second edge region is apart from the body region.

In some embodiments of the present application, the first region, the second region and the third region may respectively include electrode active materials having substantially the same charge expansion ratio.

In some embodiments of the present application, the first region, the second region and the third region respectively include electrode active materials having partially the same or completely different charge expansion ratios.

In some embodiments of the present application, the first region, the second region and the third region may respectively employ electrode active materials that are completely the same, partially the same, or completely different.

(IV) Electrode including insulating region

In some embodiments of the present application, the electrode further includes an insulating region disposed at an edge of the substrate for the function of insulation to prevent a short circuit between the anode and the cathode. In some embodiments, the insulating region includes ceramic, wherein the unit area capacity of the ceramic is 0.

### II. BATTERY CELL AND ELECTROCHEMICAL DEVICE

Embodiments of the present application further provide a battery cell and an electrochemical device using the electrode of the present application. In some embodiments, the battery cell includes a cathode and an anode. In some embodiments, the electrochemical device includes a battery cell and a housing. In some embodiments of the present application, the electrochemical device is a lithium-ion battery.

In some embodiments of the present application, the battery cell of the present application includes at least one of the cathodes described in the embodiments of the present application and the anodes described in the embodiments of the present application. The structures and compositions of the specific cathodes and anodes are described above, and are not described herein again.

The battery cell of the lithium-ion battery further includes an electrolyte, and the state of the electrolyte may be one or more of a gel state, a solid state and a liquid state. The liquid electrolyte includes a lithium salt and a non-aqueous solvent.

The lithium salt is one or more selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiBOB and LiPO₂F₂. For example, LiPF₆ is selected as the lithium salt because the lithium salt can provide a high ionic conductivity and improve cycle characteristics.

The non-aqueous solvent may be a carbonate compound, a carboxylate compound, an ether compound, an acrylic compound, other organic solvent or a combination thereof.

Examples of the carbonate compound are diethyl carbonate (DEC), dimethyl carbonate (DMC), dipropyl carbonate (DPC), methylpropyl carbonate (MPC), ethyl propyl carbonate (EPC), ethyl methyl carbonate (MEC), ethylene carbonate (EC), propylene carbonate (PC), butylene carbonate (BC), vinyl ethylene carbonate (VEC), fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, and a combination thereof.

In some embodiments, based on the total weight of the electrolyte, the content of the carbonate compound is about 1 wt % or above. In some embodiments, the content of the carbonate compound is about 3 wt % or above. In some embodiments, the content of the carbonate compound is about 5 wt % or above. In some embodiments, the content of the carbonate compound is about 10 wt % or above. In some embodiments, the content of the carbonate compound is about 50 wt % or above. In some embodiments, the content of the carbonate compound is about 58 wt % or above. In some embodiments, the content of the carbonate compound is about 60 wt % or below. In some embodiments, the content of the carbonate compound is about 50 wt % or below. In some embodiments, the content of the cyclic carbonate compound is about 40 wt % or below. In some embodiments, the content of the carbonate compound is about 1 wt % to about 60 wt %. In some embodiments, the content of the carbonate compound is about 3 wt % to about 50 wt %.

Examples of the carboxylate compound are methyl acetate, ethyl acetate, n-propyl acetate, t-butyl acetate, methyl propionate, ethyl propionate, propyl propionate, γ-butyrolactone, decalactone, valerolactone, mevalonolactone, caprolactone and a combination thereof.

In some embodiments, based on the total weight of the electrolyte, the content of the carboxylate compound is about 1 wt % or above. In some embodiments, the content of the carboxylate compound is about 3 wt % or above. In some embodiments, the content of the carboxylate compound is about 5 wt % or above. In some embodiments, the content of the carboxylate compound is about 10 wt % or above. In some embodiments, the content of the carboxylate compound is about 60 wt % or below. In some embodiments, the content of the carboxylate compound is about 50 wt % or below. In some embodiments, the content of the carboxylate compound is about 40 wt % or below. In some embodiments, the content of the carboxylate compound is about 1 wt % to about 60 wt %. In some embodiments, the content of the carboxylate compound is about 3 wt % to about 50 wt %.

Examples of the ether compound are tetrahydrofuran, 2-methyltetrahydrofuran, 1,3-dioxolane, 2-methyl 1,3-dioxolane, 4-methyl 1,3-dioxolane, 1,3-dioxane, 1,4-dioxane, dimethoxypropane, dimethoxymethane, 1,1-dimethoxyethane, 1,2-dimethoxyethane, diethoxymethane, 1,1-diethoxyethane, 1,2-diethoxyethane, ethoxymethoxymethane, 1,1-ethoxymethoxyethane, 1,2-ethoxymethoxyethane, HCF₂CF₂CH₂OCF₂CF₂H, (CF₃)₂CFCF (CF₂CF₃)(OCH₃), CF₃CHFCF₂CH(CH₃)OCF₂CHFCF₃, HCF₂CF₂CH₂OCF₂CF₂CF₂CF₂H, HCF₂CF₂OCH₂CF₃, HCF₂CF₂OCH₂CH₂OCF₂CF₂H, HCF₂CF₂OCH₂CH₂CH₂OCF₂CF₂H and a combination thereof.

In some embodiments, based on the total weight of the electrolyte, the content of the ether compound is about 0.01 wt % or above. In some embodiments, the content of the ether compound is about 0.05 wt % or above. In some embodiments, the content of the ether compound is about 1 wt % or above. In some embodiments, the content of the ether compound is about 2 wt % or above. In some embodiments, the content of the ether compound is about 10 wt % or below. In some embodiments, the content of the ether compound is about 6 wt % or below. In some embodiments, the content of the ether compound is about 5 wt % or below. In some embodiments, the content of the ether compound is about 0.01 wt % to about 10 wt %. In some embodiments, the content of the ether compound is about 1 wt % to about 6 wt %.

Examples of the nitrile compound are succinonitrile, glutaronitrile, adiponitrile, 1,5-dicyanopentane, 1,6-dicyanohexane, 1,7-dicyanoheptane, 1,8-dicyanooctane, 1,9-dicyanononane, 1,10-dicyanodecane, 1,12-dicyanododecane, tetramethylsuccinonitrile, 2-methylglutaronitrile, 2,4-dimethylglutaronitrile, 2,2,4,4-tetramethylglutaronitrile, 1,4-dicyanopentane, 1,4-dicyanopentane, 2,5-dimethyl-2,5-hexanedicarbonitrile, 2,6-dicyanoheptane, 2,7-dicyanooctane, 2,8-dicyanononane, 1,6-dicyanodecane, 1,2-dicyanobenzene, 1,3-dicyanobenzene, 1,4-dicyanobenzene, 3,5-dioxa-heptanedinitrile, 1,4-bis(cyanoethoxy)butane, ethylene glycol bis(2-cyanoethyl)ether, diethylene glycol bis(2-cyanoethyl)ether, triethylene glycol bis(2-cyanoethyl)ether, tetraethylene glycol bis(2-cyanoethyl)ether, 3,6,9,12,15,18-hexaoxaeicosanoic acid dinitrile, 1,3-bis(2-cyanoethoxy)propane, 1,4-bis(2-cyanoethoxy)butane, 1,5-bis(2-cyanoethoxy)pentane, ethylene glycol bis(4-cyanobutyl)ether, 1,3,5-pentanetricarbonitrile, 1,2,3-propanetricarbonitrile, 1,3,6-hexanetricarbonitrile, 1,2,6-hexanetricarbonitrile, 1,2,3-tris(2-cyanoethoxy)propane or 1,2,4-tris(2-cyanoethoxy)butane, and a combination thereof.

In some embodiments, based on the total weight of the electrolyte, the content of the acrylic compound is about 0.01 wt % or above. In some embodiments, the content of the acrylic compound is about 0.05 wt % or above. In some embodiments, the content of the acrylic compound is about 1 wt % or above. In some embodiments, the content of the acrylic compound is about 2 wt % or above. In some embodiments, the content of the acrylic compound is about 10 wt % or below. In some embodiments, the content of the acrylic compound is about 6 wt % or below. In some embodiments, the content of the acrylic compound is about 5 wt % or below. In some embodiments, the content of the acrylic compound is about 0.01 wt % to about 10 wt %. In some embodiments, the content of the acrylic compound is about 1 wt % to about 6 wt %.

Examples of other organic solvents are dimethyl sulfoxide, 1,3-propane sultone, sulfolane, methyl sulfolane, 1,3-dimethyl-2-imidazolidinone, N-methyl-2-pyrrolidone, formamide, dimethylformamide, trimethyl phosphate, triethyl phosphate, trioctyl phosphate, tripropyl phosphate and a combination thereof.

In some embodiments, in the battery cell of the lithium-ion battery, a separator is arranged between the cathode and the anode to prevent a short circuit. The material and shape of the separator used in the electrochemical device of the present application are not particularly limited, and may be any of the techniques disclosed in the prior art. In some embodiments, the separator includes a polymer or an inorganic substance and the like formed by a material stable in the electrolyte of the present application.

For example, the separator may include a substrate layer and a surface treatment layer. The substrate layer is a nonwoven fabric, a film or a composite film having a porous structure, and the material of the substrate layer is at least one selected from polyethylene, polypropylene, polyethylene terephthalate and polyimide. Specifically, a polypropylene porous film, a polyethylene porous film, polypropylene nonwoven cloth, polyethylene nonwoven cloth or a polypropylene-polyethylene-polypropylene porous composite film can be adopted.

At least one surface of the substrate layer is provided with the surface treatment layer, and the surface treatment layer may be a polymer layer or an inorganic substance layer, or may be a layer formed by mixing a polymer and an inorganic substance.

The inorganic substance layer includes inorganic particles and a binder, and the inorganic particles are selected from one or a combination of several of aluminum oxide, silicon oxide, magnesium oxide, titanium oxide, hafnium oxide, tin oxide, cerium oxide, nickel oxide, zinc oxide, calcium oxide, zirconium oxide, yttrium oxide, silicon carbide, boehmite, aluminum hydroxide, magnesium hydroxide, calcium hydroxide and barium sulfate. The binder is selected from one or a combination of several of polyvinylidene fluoride, vinylidene fluoride-hexafluoropropylene copolymer, polyamide, polyacrylonitrile, polyacrylate, polyacrylic acid, polyacrylate, polyvinylpyrrolidone, polyvinyl ether, polymethyl methacrylate, polytetrafluoroethylene and polyhexafluoropropylene. The polymer layer includes a polymer, and the material of the polymer is at least one selected from polyamide, polyacrylonitrile, acrylate polymer, polyacrylic acid, polyacrylate, polyvinylpyrrolidone, polyvinyl ether, polyvinylidene fluoride and poly(vinylidene fluoride-hexafluoropropylene).

The separator needs to have mechanically robustness to withstand the stretching and piercing of the electrode material, and the pore size of the separator is typically less than 1 micron. Various separators including microporous polymer membranes, non-woven mats and inorganic membranes have been used in the lithium-ion batteries, wherein the polymer membranes based on microporous polyolefin materials are the most commonly used separators in combination with the electrolyte. The microporous polymer membranes can be made very thin (typically about 5 μm-25 μm) and can be highly porous (typically about 20%-50%) to reduce electrical resistance and improve ion conductivity. Meanwhile, the polymer membrane still has mechanical robustness. Those skilled in the art will appreciate that various separators widely used in the lithium-ion batteries are suitable for use in the present application.

Although the foregoing illustrates by taking the lithium-ion battery as an example, after reading the present application, those skilled in the art can conceive that the cathode material of the present application can be used for other suitable electrochemical devices. Such electrochemical devices include any electrochemical reaction device, and specific examples thereof include all kinds of primary batteries, secondary batteries, fuel battery cells, solar battery cells or capacitors. In particular, the electrochemical device is a lithium secondary battery, including a lithium metal secondary battery, a lithium-ion secondary battery, a lithium polymer secondary battery, or a lithium-ion polymer secondary battery.

### III. APPLICATION

The electrochemical device manufactured from the electrode according to the present application is suitable for electronic devices in various fields.

The use of the electrochemical device of the present application is not particularly limited and can be used for any use known in the prior art. In one embodiment, the electrochemical device of the present application may be used for, but is not limited to, notebook computers, pen input computers, mobile computers, e-book players, portable telephones, portable fax machines, portable copy machines, portable printers, headsets, stereo headphones, VCRs, LCD TVs, portable cleaners, portable CD players, mini disc players, transceivers, electronic notebooks, calculators, memory cards, portable recorders, radios, backup powers, motors, cars, motorcycles, power bicycles, bicycles, lighting fixtures, toys, game consoles, clocks, power tools, flashlights, cameras, large household batteries, lithium-ion capacitors, and the like.

Hereinafter, a lithium-ion battery is taken as an example and combined with a specific embodiment for preparing a cathode material of the present application and a measuring method for an electrochemical device to explain the preparation and performance of the lithium-ion battery of the present application. Those skilled in the art will appreciate that the preparation methods described in the present application are merely examples, and any other suitable preparation method is within the scope of the present application.

### IV. EMBODIMENTS

Preparation of Lithium-Ion Battery

The cathode active material was prepared into a lithium-ion battery by adopting the following preparation method. Specifically, the cathode active material, a conductive agent and a binder were sufficiently stirred and uniformly mixed in a certain weight ratio in N-methylpyrrolidone to form a cathode slurry. Then the obtained cathode slurry was uniformly coated on the front and back surfaces of the aluminum foil of a cathode current collector and dried at 85° C. to obtain a cathode active material layer. Afterward, the cathode active material layer was subjected to cold pressing, slitting, slice cutting and welding of a cathode tab to obtain a cathode.

The anode active material, a binder and a dispersant were sufficiently stirred and uniformly mixed in a certain weight ratio in deionized water to form an anode slurry. Then the obtained anode slurry was uniformly coated on the front and back surfaces of the copper foil of an anode current collector and dried at 85° C. to obtain an anode active material layer. Afterward, the anode active material layer was subjected to cold pressing, slitting, slice cutting and welding of the anode tab to obtain an anode.

The lithium salt LiPF₆ and the non-aqueous organic solvent (ethylene carbonate (EC): diethyl carbonate (DEC): propylene carbonate (PC): propyl propionate (PP): vinylene carbonate (VC)=20:30:20:28:2, mass ratio) were prepared to a solution according to the mass ratio of 8:92, as an electrolyte of the lithium-ion battery.

The separator was made of a ceramic-coated polyethylene (PE) material separator.

The cathode, the separator, and the anode were stacked in order, so that the separator was between the cathode and the anode for the function of isolation. The electrode assembly was placed in a package, the electrolyte was injected, packaging was performed, and then formation was performed to obtain the final lithium-ion battery.

Tests for Electrode Thickness and Charge/Discharge Thickness Difference

Thickness test: electrode thickness measurement was performed by using a 0.1 μm high precision digital micrometer (Mitutoyo brand). The assembled battery cell was disassembled, the electrode was taken out, and the surface residue was washed away with diethyl carbonate (DEC) solvent; the micrometer test head was wiped with dust-free paper to remove foreign matters to ensure the test accuracy; and the electrode was put into the micrometer test head, the micrometer handle was rotated to closely contact the electrode, and the thickness value was read. Ten different points on the electrode were selected and ten thickness data was averaged.

Charge/discharge thickness difference test: the electrode was charged or discharged to a suitable voltage (greater than the charge or discharge lower limit cut-off voltage of the active material) to partially or completely deintercalate the lithium in the electrode, and the thickness of the electrode was measured according to the above thickness test method; and then, the electrode was charged or discharged to a suitable voltage (less than the charge or discharge upper limit cut-off voltage of the active material) to intercalate the lithium into the electrode, the thickness of the electrode was measured according to the above thickness test method, and the difference between the two test thicknesses was calculated.

Specific embodiments of the electrodes provided by the present application will be described in detail below.

### (I) Embodiment 1 and Comparative Example 1

Embodiment 1 relates to partitioned coating on the cathode and no partitioned coating on the anode. The preparation methods of the cathodes in Embodiment 1 and Comparative Example 1 will be specifically described below:

### Preparation Method of Electrode of Embodiment 1

(1) Preparation of Slurry

Cathode LiNi_{0.8}Mn_{0.1}Co_{0.1}O₂ slurry: a cathode active component LiNi_{0.8}Mn_{0.1}Co_{0.1}O₂, conductive carbon black and a binder polyvinylidene fluoride PVDF were mixed according to a weight ratio of 97%: 1.5%: 1.5%, diluted with an appropriate amount of N-methylpyrrolidone, and then stirred in a vacuum mixer to form a uniform cathode slurry.

Cathode LiNi_{0.8}Mn_{0.1}Co_{0.1}O₂+LiCoO₂ slurry: a cathode active component (50 wt % of LiNi_{0.8}Mn_{0.1}Co_{0.1}O₂ and 50 wt % of LiCoO₂), conductive carbon black and a binder polyvinylidene fluoride PVDF were mixed according to a weight ratio of 97%:1.5%:1.5%, diluted with an appropriate amount of N-methylpyrrolidone, and then stirred in a vacuum mixer to form a uniform cathode slurry.

Anode slurry: an anode active component graphite, a binder styrene-butadiene rubber SBR and a dispersant carboxymethyl cellulose CMC were mixed according to a weight ratio of 97%:1%:2%, diluted with an appropriate amount of distilled water, and then stirred in a vacuum mixer to form a uniform anode slurry.

(2) Cathode Partitioned Coating

Cathode partitioned coating: Partitioned coating was performed as follows:

A. The LiNi_{0.8}Mn_{0.1}Co_{0.1}O₂ slurry prepared in step (1) was coated on the body region (hereinafter referred to as the first cathode region) of one side of the aluminum foil by a body coating head, and the LiNi_{0.8}Mn_{0.1}Co_{0.1}O₂+LiCoO₂ slurry prepared in step (1) was coated on a region that is 10 mm from the edge of the body region (hereinafter referred to as the second cathode region) of the side by an edge coating head. The coated single-sided electrode was dried in a high-temperature oven at 85° C.;

B. The above single-sided coated electrode was subjected to the second side coating, and the coating method, regions and materials were the same as described in step A. The coated double-sided electrode was dried in a high-temperature oven at 85° C. to obtain the cathode of Embodiment 1.

(3) Anode Coating

C. The anode slurry prepared in step (1) was coated on one side of the copper foil substrate, and the coated single-sided electrode was dried in a high-temperature oven at 85° C.;

D. The above single-sided coated electrode was subjected to the second side coating, and the coating method, regions and materials were the same as described in step C. The coated double-sided electrode was dried in a high-temperature oven at 85° C. to obtain the anode of Embodiment 1.

### Preparation Method of Electrode of Comparative Example 1

Comparative Example 1 differs from Embodiment 1 only in that the cathode was not subjected to partitioned coating, and the cathode LiNi_{0.8}Mn_{0.1}Co_{0.1}O₂ slurry was coated on the body region of the aluminum foil according to a conventional process.

TABLE 1

| | | | | | Thick- | Thick- | | | Thick- | Thick- |
|---|---|---|---|---|---|---|---|---|---|---|
| | | | Thick- | Thick- | ness | ness | Thick- | Thick- | ness | ness |
| | | | ness | ness | of the | of the | ness | ness | of the | of the |
| | | | of the | of the | first | second | of the | of the | first | second |
| | | | pre- | pre- | cathode | cathode | first | second | anode | anode |
| | | | pared | pared | region | region | anode | anode | region | region |
| | The | The | first | second | after | after | region | region | after | after |
| | first | second | cathode | cathode | forma- | forma- | before | before | 500 | 500 |
| | cathode | cathode | region | region | tion | tion | cycle | cycle | cycles | cycles |
| | region | region | (μm) | (μm) | (μm) | (μm) | (μm) | (μm) | (μm) | (μm) |
| Embodi- | LiNi_{0.8}- | 50wt% | 121.1 | 116.8 | 125.9 | 124.8 | 98.5 | 96.7 | 118.2 | 116.0 |
| ment 1 | Mn_{0.1}- | LiNi_{0.8}- | | | | | | | | |
| | Co_{0.1}O₂ | Mn_{0.1}- | | | | | | | | |
| | | Co_{0.1}O₂ | | | | | | | | |
| | | +50wt% | | | | | | | | |
| | | LiCoO₂ | | | | | | | | |
| Compar- | LiNi_{0.8}- | LiNi_{0.8}- | 120.8 | 114.3 | 125.6 | 118.9 | 98.6 | 96.6 | 118.3 | 132.9 |
| ative | Mn_{0.1}- | Mn_{0.1}- | | | | | | | | |
| Example | Co_{0.1}O₂ | Co_{0.1}O₂ | | | | | | | | |
| 1 | | | | | | | | | | |

*Please note that the thickness data in the first 4 columns in Table 1 is the thickness of the cathode, and the thickness data in the last 4 columns is the thickness of the fully charged anode. In the lithium-ion battery, the lithium deposition phenomenon of the anode is more serious than that of the cathode. Therefore, the subject application mainly uses the thickness parameter of the anode to measure the degree of lithium deposition of the lithium-ion battery, thereby reflecting the safety performance of the lithium-ion battery.

Referring to the thickness data of the first 4 columns shown in Table 1, the thicknesses of the second regions of the prepared cathodes of Comparative Example 1 and Embodiment 1 were smaller than those of the first regions. However, since the charge expansion ratio of lithium cobalt oxide is greater than the charge expansion ratio of the ternary material, the large expansion of the cathode material in the second region in Embodiment 1 compensates for the charge/discharge thickness difference of the first region electrode and the second region electrode in the formation stage, thereby obtaining a cathode having a first region thickness and a second region thickness being substantially equal. Referring to the thickness data of the last 4 columns shown in Table 1, it is understood that the thickness of the second region of the anode in Embodiment 1 is much lower than the thickness of the second region of the anode in Comparative Example 1 after 500 charge and discharge cycles. This indicates that the degree of lithium deposition of the anode in Embodiment 1 is much smaller than that of the anode in Comparative Example 1.

### (II) Embodiments 2A-5 and Comparative Examples 2-5

Embodiments 2A-5 and Comparative Examples 2A-5 relate only to partitioned coating on the anode and no partitioned coating on the cathode. The preparation methods of the anodes in Embodiments 2A-5 and Comparative Examples 2A-5 will be specifically described below:

### Preparation Method of Electrode of Embodiment 2A

(1) Preparation of Slurry

Graphite slurry of anode A type graphite (OI value being 12, degree of graphitization being 92%): an anode active component A type graphite, a binder styrene-butadiene rubber SBR and a dispersant carboxymethyl battery cellulose CMC were mixed according to a weight ratio of 97%:1%:2%, diluted with an appropriate amount of distilled water, and then stirred in a vacuum mixer to form a uniform anode slurry.

Graphite slurry of anode B type graphite (01 value being 19, degree of graphitization being 92%): an anode active component B type graphite (01 value being 19), a binder styrene-butadiene rubber SBR and a dispersant carboxymethyl battery cellulose CMC were mixed according to a weight ratio of 97%:1%:2%, diluted with an appropriate amount of distilled water, and then stirred in a vacuum mixer to form a uniform anode slurry.

Cathode slurry: a cathode active component LiNi_{0.8}Mn_{0.1}Co_{0.1}O₂, conductive carbon black and a binder polyvinylidene fluoride PVDF were mixed according to a weight ratio of 97%:1.5%:1.5%, diluted with an appropriate amount of N-methylpyrrolidone, and then stirred in a vacuum mixer to form a uniform cathode slurry.

(2) Anode Partitioned Coating

Anode partitioned coating: Partitioned coating was performed as follows:

A. The A type graphite slurry prepared in step (1) was coated on the body region (hereinafter referred to as the first anode region) of one side of the copper foil by a body coating head, and the B type graphite slurry prepared in step (1) was coated on a region that is 10 mm from the edge of the body region (hereinafter referred to as the second anode region) of the side by an edge coating head. The coated single-sided electrode was dried in a high-temperature oven at 85° C.;

B. The above single-sided coated electrode was subjected to a coating on the second side, and the coating method, regions and materials were the same as described in step A. The coated double-sided electrode was dried in a high-temperature oven at 85° C. to obtain the anode of Embodiment 2.

(3) Cathode Coating

C. The cathode slurry prepared in step (1) was coated on one side of the aluminum foil substrate, and the coated single-sided electrode was dried in a high-temperature oven at 85° C.;

D. The above single-sided coated electrode was subjected to a coating of the second side, and the coating method, regions and materials were the same as described in step C. The coated double-sided electrode was dried in a high-temperature oven at 85° C. to obtain the cathode of Embodiment 1.

### Preparation Methods of Electrodes of Embodiments 2B-5

Embodiments 2B-5 differ from Embodiment 2A only in that the formulations of the slurry of the first anode region, the slurry of the second anode region and the slurry of the cathode were changed. The specific formulations are shown in Table 2.

### Preparation Methods of Electrodes of Comparative Examples 2B-5

Comparative Examples 2B-5 respectively correspond to Embodiments 2B-5. Comparative Examples 2B-5 differ from the respective embodiments only in that the anode was not subjected to partitioned coating, and the first anode region slurry was coated on the body region of the copper foil according to a conventional process.

TABLE 2

| | The slurry in the first | The slurry in the | |
|---|---|---|---|
| EMBODIMENTS | anode region | second anode region | Cathode slurry |
| Embodiment 2B | Anode active | Anode active | Cathode active |
| | component C type | component D type | component LiCoO₂, |
| | graphite (OI value | graphite (OI value | conductive carbon black |
| | being 12, degree of | being 19, degree of | and binder |
| | graphitization being | graphitization being | polyvinylidene fluoride |
| | 97%), binder styrene- | 97%), binder styrene- | PVDF mixed according |
| | butadiene rubber | butadiene rubber SBR | to a weight ratio of |
| | SBR and dispersant | and dispersant | 97.5%:1%:1.5% |
| | carboxymethyl | carboxymethyl | |
| | cellulose CMC mixed | cellulose CMC mixed | |
| | according to a weight | according to a weight | |
| | ratio of | ratio of | |
| | 97.2%:1%:1.8% | 97.2%:1%:1.8% | |
| Embodiment 3A | Anode active | Anode active | Cathode active |
| | component E type | component F type | component LiCoO₂, |
| | graphite (degree of | graphite (degree of | conductive carbon black |
| | graphitization | graphitization G = 96%, | and binder |
| | G = 93%, OI value | OI value being 10), | polyvinylidene fluoride |
| | being 10), binder | binder styrene- | PVDF mixed according |
| | styrene-butadiene | butadiene rubber SBR | to a weight ratio of |
| | rubber SBR and | and dispersant | 97.5%:1%:1.5% |
| | dispersant | carboxymethyl | |
| | carboxymethyl | cellulose CMC mixed | |
| | cellulose CMC mixed | according to a weight | |
| | according to a weight | ratio of | |
| | ratio of | 97.2%:1%:1.8% | |
| | 97.2%:1%:1.8% | | |
| Embodiment 3B | Anode active | Anode active | Cathode active |
| | component E type | component F type | component |
| | graphite (degree of | graphite (degree of | LiNi_{0.8}Mn_{0.1}Co_{0.1}O₂, |
| | graphitization | graphitization G = 96%, | conductive carbon black |
| | G = 93%, OI value | OI value being 20), | and binder |
| | being 20), binder | binder styrene- | polyvinylidene fluoride |
| | styrene-butadiene | butadiene rubber SBR | PVDF mixed according |
| | rubber SBR and | and dispersant | to a weight ratio of |
| | dispersant | carboxymethyl | 97.7%:1%:1.3% |
| | carboxymethyl | cellulose CMC mixed | |
| | cellulose CMC mixed | according to a weight | |
| | according to a weight | ratio of | |
| | ratio of | 97.2%:1%:1.8% | |
| | 97.2%:1%:1.8% | | |
| Embodiment 4 | Anode active | Anode active | Cathode active |
| | component A type | component (60% of A | component |
| | graphite, binder | type graphite+40% of | LiNi_{0.8}Mn_{0.1}Co_{0.1}O₂, |
| | styrene-butadiene | silicon), conductive | conductive carbon black |
| | rubber SBR and | carbon black, binder | and binder |
| | dispersant | acrylic resin PAA and | polyvinylidene fluoride |
| | carboxymethyl | dispersant | PVDF mixed according |
| | cellulose CMC mixed | carboxymethyl | to a weight ratio of |
| | according to a weight | cellulose CMC mixed | 97.7%:1%:1.3% |
| | ratio of | according to a weight | |
| | 97.5%:1.5%:1% | ratio of | |
| | | 95%:1%:3%:1% | |
| Embodiment 5 | Anode active | Anode active | Cathode active |
| | component hard | component silicon, | component |
| | carbon, conductive | conductive carbon | LiNi_{0.8}Mn_{0.1}Co_{0.1}O₂, |
| | carbon black, binder | black, binder acrylic | conductive carbon black |
| | acrylic resin PAA | resin PAA and | and binder |
| | and dispersant | dispersant | polyvinylidene fluoride |
| | carboxymethyl | carboxymethyl | PVDF mixed according |
| | cellulose CMC mixed | cellulose CMC mixed | to a weight ratio of |
| | according to a weight | according to a weight | 96.5%:1.5%:2% |
| | ratio of | ratio of | |
| | 95%:1%:3%:1% | 95%:1.5%:2.5%:1% | |

Referring to the thickness data of the first 4 columns shown in Table 3, the thicknesses of the second regions of the prepared anodes of Comparative Examples 2A-2B and Embodiments 2A-2B were smaller than those of the first regions of the anodes. However, since the charge expansion ratio of graphite having a large OI value is greater than the charge expansion ratio of graphite having a small OI value, the expansion of the second region graphite in Embodiments 2A-2B in the formation stage compensates for the charge/discharge thickness difference of the first region electrode and the second region electrode, thereby obtaining an anode having a first region thickness and a second region thickness being substantially equal. Referring to the thickness data of the last 4 columns shown in Table 3, the second region thicknesses of the anodes in Embodiments 2A-2B were much lower than the second region thicknesses of the anodes in Comparative Examples 2A-2B after 500 charge and discharge cycles. This indicates that the degree of lithium deposition of the anodes in Embodiments 2A-2B is much smaller than that of the anodes in Comparative Examples 2A-2B.

TABLE 3

| | | | | | Thick- | Thick- | | | Thick- | Thick- |
|---|---|---|---|---|---|---|---|---|---|---|
| | | | Thick- | Thick- | ness | ness | Thick- | Thick- | ness | ness |
| | | | ness | ness | of the | of the | ness | ness | of the | of the |
| | | | of the | of the | first | second | of the | of the | first | second |
| | | | pre- | pre- | anode | anode | first | second | anode | anode |
| | | | pared | pared | region | region | anode | anode | region | region |
| | | | anode | second | after | after | region | region | after | after |
| | The first | The second | first | anode | forma- | forma- | before | before | 500 | 500 |
| | anode | anode | region | region | tion | tion | cycle | cycle | cycles | cycles |
| | region | region | (mm) | (mm) | (mm) | (mm) | (μm) | (μm) | (μm) | (μm) |
| Em- | Graphite | Graphite | | | | | | | | |
| bodi- | having OI | having OI | 74.7 | 72.3 | 91.2 | 90.8 | 95.3 | 95.4 | 115.2 | 114.9 |
| ment | value of 12 | value of 19 | | | | | | | | |
| 2A | (degree of | (degree of | | | | | | | | |
| | graphi- | graphi- | | | | | | | | |
| | tization | tization | | | | | | | | |
| | being 92%) | being 92%) | | | | | | | | |
| Em- | Graphite | Graphite | 74.3 | 72.1 | 94.9 | 94.5 | 99.1 | 99.8 | 119.8 | 118.3 |
| bodi- | having OI | having OI | | | | | | | | |
| ment | value of 12 | value of 19 | | | | | | | | |
| 2B | (degree of | (degree of | | | | | | | | |
| | graphi- | graphi- | | | | | | | | |
| | tization | tization | | | | | | | | |
| | being 97%) | being 97%) | | | | | | | | |
| Com- | Graphite | Graphite | 75.1 | 73.6 | 91.6 | 89.8 | 95.7 | 93.9 | 116.1 | 142.3 |
| para- | having OI | having OI | | | | | | | | |
| tive | value of 12 | value of 12 | | | | | | | | |
| Exam- | (degree of | (degree of | | | | | | | | |
| ple 2A | graphi- | graphi- | | | | | | | | |
| | tization | tization | | | | | | | | |
| | being 92%) | being 92%) | | | | | | | | |
| Com- | Graphite | Graphite | 74.8 | 71.9 | 95.0 | 92.4 | 99.8 | 97.4 | 119.8 | 143.6 |
| para- | having OI | having OI | | | | | | | | |
| tive | value of 12 | value of 12 | | | | | | | | |
| Exam- | (degree of | (degree of | | | | | | | | |
| ple 2B | graphi- | graphi- | | | | | | | | |
| | tization | tization | | | | | | | | |
| | being 97%) | being 97%) | | | | | | | | |
| Em- | Graphite | Graphite | 77.9 | 75.8 | 95.0 | 94.5 | 99.3 | 99.2 | 121.1 | 121.9 |
| bodi- | having | having | | | | | | | | |
| ment | degree of | degree of | | | | | | | | |
| 3A | graphi- | graphi- | | | | | | | | |
| | tization | tization | | | | | | | | |
| | of 93% (OI | of 96% (OI | | | | | | | | |
| | value = 10) | value = 10) | | | | | | | | |
| Em- | Graphite | Graphite | 77.4 | 75.5 | 97.3 | 96.9 | 101.1 | 100.6 | 125.5 | 124.8 |
| bodi- | having | having | | | | | | | | |
| ment | degree of | degree of | | | | | | | | |
| 3B | graphi- | graphi- | | | | | | | | |
| | tization | tization | | | | | | | | |
| | of 93% (OI | of 96% (OI | | | | | | | | |
| | value = 20) | value = 20) | | | | | | | | |
| Com- | Graphite | Graphite | 78.3 | 76.8 | 95.5 | 93.7 | 99.8 | 97.9 | 120.3 | 139.5 |
| para- | having | having | | | | | | | | |
| tive | degree of | degree of | | | | | | | | |
| Exam- | graphi- | graphi- | | | | | | | | |
| ple 3A | tization | tization | | | | | | | | |
| | of 93% (OI | of 93% (OI | | | | | | | | |
| | value = 10) | value = 10) | | | | | | | | |
| Com- | Graphite | Graphite | 77.2 | 75.1 | 99.6 | 96.9 | 104.4 | 101.5 | 129.5 | 153.7 |
| para- | having | having | | | | | | | | |
| tive | degree of | degree of | | | | | | | | |
| Exam- | graphi- | graphi- | | | | | | | | |
| ple 3B | tization | tization | | | | | | | | |
| | of 93% (OI | of 93% (OI | | | | | | | | |
| | value = 20) | value = 20) | | | | | | | | |
| Embodi- | Graphite | Graphite + | 82.4 | 81.9 | 100.5 | 100.8 | 105.0 | 105.5 | 126.2 | 127.1 |
| ment 4 | | silicon | | | | | | | | |
| Compar- | Graphite | Graphite | 82.6 | 81.3 | 100.8 | 99.2 | 105.3 | 103.7 | 125.9 | 151.9 |
| ative | | | | | | | | | | |
| Exam- | | | | | | | | | | |
| ple 4 | | | | | | | | | | |
| Embodi- | Hard | Silicon | 64.4 | 63.0 | 78.6 | 78.0 | 82.1 | 81.7 | 98.5 | 99.1 |
| ment 5 | carbon | | | | | | | | | |
| Compar- | Hard | Hard | 65.0 | 63.6 | 79.3 | 77.6 | 82.9 | 81.1 | 99.0 | 123.8 |
| ative | carbon | carbon | | | | | | | | |
| Exam- | | | | | | | | | | |
| ple 5 | | | | | | | | | | |

*Please note that the thickness data in Table 3 is the data of a fully charged anode.

Referring to the thickness data of the first 4 columns shown in Table 3, the second region thicknesses of the prepared anodes of Comparative Examples 3A-3B and Embodiments 3A-3B were smaller than the first region thicknesses of the anodes. However, since the charge expansion ratio of graphite having a higher degree of graphitization is greater than the charge expansion ratio of graphite having a lower degree of graphitization, the expansion of the second region graphite in Embodiments 3A-3B in the formation stage compensates for the charge/discharge thickness difference of the first region electrode and the second region electrode, thereby obtaining an anode having a first region thickness and a second region thickness being substantially equal. Referring to the thickness data of the last 4 columns shown in Table 3, the second region thicknesses of the anodes in Embodiments 3A-3B were much lower than the second region thicknesses of the anodes in Comparative Examples 3A-3B after 500 charge and discharge cycles. This indicates that the degree of lithium deposition of the anodes in Embodiments 3A-3B was much smaller than that of the anodes in Comparative Examples 3A-3B.

Similarly, since the charge expansion ratio of silicon is greater than the charge expansion ratio of graphite and hard carbon, the expansions of the anode active materials of the second regions in Embodiments 4 and 5 in the formation stage compensate for the charge/discharge thickness difference of the first region electrode and the second region electrode, thereby obtaining an anode having a first region thickness and a second region thickness being substantially equal. The thickness data of the last 4 columns shown in Table 3 shows that the degree of lithium deposition of the anodes in Embodiments 4 and 5 was less than that of the anodes in Comparative Examples 4 and 5 after 500 charge and discharge cycles.

Based on the data of the above embodiments and comparative examples, it can be seen that by compensating the thickness of the thin region of the electrode in the prior art such that the thicknesses of different regions in the electrode are substantially the same, the local separation of the electrode can be alleviated or avoided, thereby effectively inhibiting the formation of lithium dendrites and greatly enhancing the safety performance of the lithium-ion battery.

### (III) Embodiments 6-8

As compared with Embodiments 1-5 above, a third region was further added in the electrodes of Embodiments 6-8. The third region is adjacent to the second region but apart from the first region. The third region is a region that is 10 mm from the edge of the second region.

Preparation methods of electrodes of Embodiments 6-8:

Embodiment 6 differs from Embodiment 1 only in that the LiCoO₂ slurry was further coated on the third region of the electrode. The preparation process of the LiCoO₂ slurry was the same as the preparation process of the LiNi_{0.8}Mn_{0.1}Co_{0.1}O₂ slurry.

Embodiment 7 differs from Embodiment 2 only in that the E type graphite slurry having an OI value of 25 was further coated on the third region of the electrode. The preparation process of the E type graphite slurry was the same as the preparation process of the A type graphite slurry.

Embodiment 8 differs from Embodiment 4 only in that the silicon slurry was further coated on the third region of the electrode. The preparation process of the silicon slurry was the same as the preparation process of the graphite+silicon slurry.

TABLE 4

| | | | | Thick- | Thick- | | | | |
|---|---|---|---|---|---|---|---|---|---|
| | | | | ness | ness | | | | |
| | | | | of the | of the | | | | |
| | | | | prepared | prepared | | | | |
| | | The | The | first | second | | | | |
| | The first | second | third | cathode/ | cathode/ | | | | |
| | cathode/ | cathode/ | cathode/ | anode | anode | Thickness of the | | | |
| | anode | anode | anode | region | region | prepared third cathode/ | | | |
| | region | region | region | (mm) | (mm) | anode region (mm) | | | |
| Em- | LiNi_{0.8}- | 50wt% | LiCoO₂ | 121.3 | 116.2 | 113.9 | | | |
| bodi- | Mn_{0.1}- | LiNi_{0.8}- | | | | | | | |
| ment 6 | Co_{0.1}O₂ | Mn_{0.1}- | | | | | | | |
| | | Co_{0.1}O₂ | | | | | | | |
| | | +50wt%- | | | | | | | |
| | | LiCoO₂ | | | | | | | |
| Em- | Graphite | Graphite | Graphite | 75.1 | 72.8 | 70.3 | | | |
| bodi- | having | having | having | | | | | | |
| ment 7 | OI | OI | OI | | | | | | |
| | value | value | value | | | | | | |
| | of 12 | of 19 | of 25 | | | | | | |
| Em- | Graphite | 60% of | Silicon | 82.1 | 79.4 | 76.8 | | | |
| bodi- | | graphite | | | | | | | |
| ment 8 | | +40% | | | | | | | |
| | | of silicon | | | | | | | |
| | Thick- | Thick- | Thick- | | | | Thick- | Thick- | Thick- |
| | ness | ness | ness | Thick- | Thick- | Thick- | ness | ness | ness |
| | of the | of the | of the | ness | ness | ness | of the | of the | of the |
| | first | second | third | of the | of the | of the | first | second | third |
| | cathode/ | cathode/ | cathode/ | first | second | third | anode | anode | anode |
| | anode | anode | anode | anode | anode | anode | region | region | region |
| | region | region | region | region | region | region | after | after | after |
| | after | after | after | before | before | before | 500 | 500 | 500 |
| | formation | formation | formation | cycle | cycle | cycle | cycles | cycles | cycles |
| | (mm) | (mm) | (mm) | (μm) | (μm) | (μm) | (μm) | (μm) | (μm) |
| Em- | 126.1 | 124.9 | 125.1 | 98.7 | 96.4 | 96.2 | 118.8 | 116.7 | 115.5 |
| bodi- | | | | | | | | | |
| ment 6 | | | | | | | | | |
| Em- | 90.9 | 91.1 | 90.5 | 95.7 | 95.6 | 94.8 | 115.5 | 114.3 | 113.9 |
| bodi- | | | | | | | | | |
| ment 7 | | | | | | | | | |
| Em- | 100.5 | 100.8 | 111.0 | 105.0 | 105.5 | 104.9 | 126.2 | 127.1 | 126.8 |
| bodi- | | | | | | | | | |
| ment 8 | | | | | | | | | |

Referring to the data in Table 4, it can be seen that regardless of the thicknesses of the first-third regions of the electrodes in the preparation stage of the electrodes, as long as the thicknesses of the first-third regions of the electrodes were substantially equal in the formation stage of the battery cell, after 500 charge and discharge cycles, the thickness variations of the electrodes in Embodiments 6-8 were not large, and the formation of lithium dendrites was effectively inhibited, thereby enhancing the safety performance of the battery cells.

References to “some embodiments”, “part of embodiments”, “one embodiment”, “another example”, “example”, “specific example” or “part of examples” in the whole specification mean that at least one embodiment or example in present application includes specific features, structures, materials or characteristics described in the embodiments or examples. Thus, the descriptions appear throughout the specification, such as “in some embodiments”, “in an embodiment”, “in one embodiment”, “in another example”, “in one example”, “in a specific example” or “an example”, which does not necessarily refer to the same embodiment or example in the present application. Furthermore, the specific features, structures, materials or characteristics in the descriptions can be combined in any suitable manner in one or more embodiments or examples.

Although the illustrative embodiments have been shown and described, it should be understood by those skilled in the art that the above embodiments cannot be interpreted as limiting the present application, and the embodiments can be changed, substituted and modified without departing from the spirit, principle and scope of the present application.

What is claimed is:

1. An electrode, comprising a first region and a second region,
wherein the electrode comprises a substrate and an electrode active material coated on at least one surface of the substrate; a charge/discharge thickness difference of the electrode in the first region is ΔD₁, and the charge/discharge thickness difference of the electrode in the second region is ΔD₂; and ΔD₁ is less than ΔD₂.

2. The electrode according to claim 1, wherein a thickness of the electrode in the first region is L₁, the thickness of the electrode in the second region is L₂, and L₂ is substantially equal to L₁.

3. The electrode according to claim 1, wherein the first region comprises a body region, and the second region comprises an edge region.

4. The electrode according to claim 1, wherein the first region and the second region respectively comprise electrode active materials having substantially the same charge expansion ratio or electrode active materials having different charge expansion ratios.

5. The electrode according to claim 1, wherein the electrode active material in the first region comprises a ternary material, and the electrode active material in the second region comprises lithium cobalt oxide.

6. The electrode according to claim 1, wherein the electrode active material in the first region and the electrode active material in the second region comprise a carbon material; and the OI value of the carbon material in the first region is less than the OI value of the carbon material in the second region.

7. The electrode according to claim 1, wherein the electrode active material in the first region and the electrode active material in the second region comprise a carbon material; and the degree of graphitization of the carbon material in the first region is less than the degree of graphitization of the carbon material in the second region.

8. The electrode according to claim 1, wherein the electrode active material in the first region comprises graphite, and the electrode active material in the second region comprises silicon.

9. The electrode according to claim 1, wherein the electrode active material in the first region comprises hard carbon, and the electrode active material in the second region comprises graphite and/or silicon.

10. A battery cell, comprising the electrode, wherein the electrode comprises a first region and a second region,
wherein the electrode comprises a substrate and an electrode active material coated on at least one surface of the substrate, a charge/discharge thickness difference of the electrode in the first region is ΔD₁, and the charge/discharge thickness difference of the electrode in the second region is ΔD₂ and ΔD₁ is less than ΔD₂.

11. The battery cell according to claim 10, wherein a thickness of the electrode in the first region is L₁, and a thickness of the electrode in the second region is L₂, and L₂ is substantially equal to Li.

12. The battery cell according to claim 10, wherein the first region comprises a body region, and the second region comprises an edge region.

13. The battery cell according to claim 10, wherein the first region and the second region respectively comprise electrode active materials having substantially the same charge expansion ratio or electrode active materials having different charge expansion ratios.

14. The battery cell according to claim 10, wherein the electrode active material in the first region comprises a ternary material, and the electrode active material in the second region comprises lithium cobalt oxide.

15. The battery cell according to claim 10, wherein the electrode active material in the first region and the electrode active material in the second region comprise a carbon material; and the OI value of the carbon material in the first region is less than the OI value of the carbon material in the second region.

16. The battery cell according to claim 10, wherein the electrode active material in the first region and the electrode active material in the second region comprise a carbon material; and the degree of graphitization of the carbon material in the first region is less than the degree of graphitization of the carbon material in the second region.

17. The battery cell according to claim 10, wherein the electrode active material in the first region comprises graphite, and the electrode active material in the second region comprises silicon.

18. The battery cell according to claim 10, wherein the electrode active material in the first region comprises hard carbon, and the electrode active material in the second region comprises graphite and/or silicon.
